(19) United States
(12) Patent Application Publication
(10) Pub. No.: US 2026/0338344 A1
(43) Pub. Date: Oct. 29, 2026

(54) LAMP FOR VEHICLE

(71) Applicant: HYUNDAI MOBIS CO., LTD., Seoul (KR)

(72) Inventor: Min Ji JIN, Yongin-si (KR)

(73) Assignee: HYUNDAI MOBIS CO., LTD., Seoul (KR)

(21) Appl. No.: 19/549,151

(22) Filed: Feb. 25, 2026

(30) Foreign Application Priority Data
Apr. 25, 2025 (KR) 10-2025-0054604

(51) Int. Cl. F21S 41/365; F21S 41/265; F21S 41/32; F21W 102/20

(52) U.S. Cl. CPC F21S 41/365; F21S 41/265; F21S 41/321; F21S 41/322; F21W 2102/20

(57) ABSTRACT

A vehicle lamp includes a first light source unit comprising first light source parts and disposed at one lateral side; a second light source unit comprising second light source parts and disposed laterally adjacent to the first light source unit; a third light source unit comprising one or more third light source parts and disposed above the first light source unit and the second light source unit; an incident lens formed as an integral body comprising a first lens portion and a second lens portion; and an emergent lens disposed forward of the incident lens and comprising a first emergent lens part and a second emergent lens part integrated with each other, wherein the incident lens is configured such that light beams emitted from the third light source unit are sequentially reflected by a first reflection surface and a second reflection surface before entering the emergent lens.

### CROSS-REFERENCE TO RELATED APPLICATION

This application claims priority to and the benefit under 35 USC § 119(a) of Korean Patent Application No. 10-2025-0054604 filed in the Korean Intellectual Property Office on Apr. 25, 2025, the entire contents of which are incorporated herein by reference for all purposes.

### TECHNICAL FIELD

The present disclosure relates to a lamp for a vehicle.

### BACKGROUND ART

A vehicle is equipped with various types of lamps having a lighting function and a signal function. The lighting function allows a driver to easily recognize objects positioned around the vehicle during nighttime driving. The signal function informs drivers in other vehicles and pedestrians on the road of a traveling state of the host vehicle.

For example, the vehicle is equipped with headlamps (or headlights) and fog lamps used for the lighting function, and turn signal lamps, tail lamps, brake lamps, and side markers used for the signal function. The regulations define the installation criteria and specifications of these lamps for a vehicle to enable the lamps to sufficiently exhibit the functions.

Meanwhile, among the lamps applied to the vehicle, the headlamp forms a low-beam pattern or a high-beam pattern in order to ensure forward visibility of a driver during driving at night. In the case of a low beam rod that is disposed below a high beam rod of the headlamp and emits light, a TIR optical system in a projection lens is visible from the front side, which causes a problem in that uniformity of the lens deteriorates. Specifically, there is a problem in that the high beam of the vehicle is turned off in case that the low beam of the vehicle is turned on and another vehicle is present forward of the host vehicle during driving at night. For example, an overall illumination image of the headlamp becomes imbalanced.

### SUMMARY

The present disclosure has been made in an effort to eliminate non-uniformity of images, which occurs when a low beam is turned on together with a high beam, and improve heterogeneity of light-emitting images of the high and low beams.

In order to achieve the above-mentioned object, one aspect of the present disclosure provides a lamp for a vehicle, the lamp including: a first light source unit including one or more first light source parts and disposed at one lateral side; a second light source unit including one or more second light source parts and disposed laterally adjacent to the first light source unit; a third light source unit including one or more third light source parts and disposed above the first light source unit and the second light source unit; an incident lens formed as an integral body comprising a first lens portion and a second lens portion, wherein the first lens portion is configured to condense light beams emitted from the one or more first light source parts and guide the light beams forward, and wherein the second lens portion is disposed adjacent to the first lens portion and is configured to condense light beams emitted from the one or more second light source parts and guide the light beams forward; and an emergent lens disposed forward of the incident lens and including a first emergent lens part and a second emergent lens part integrated with each other, in which the incident lens comprises a first reflection surface and a second reflection surface spaced apart from each other in a vertical direction, and in which the incident lens is configured such that light beams emitted from the third light source unit are sequentially reflected by the first reflection surface and the second reflection surface before entering the emergent lens.

An upper surface of the incident lens may be formed to be inclined downward toward the emergent lens.

An upper surface of the second lens portion may be stepped downward relative to an upper surface of the first lens portion.

The incident lens may further include a total reflection region configured to condense the light beams emitted from the one or more third light source parts and guide the light beams forward.

The total reflection region may protrude rearward from an upper end region of the incident lens.

The total reflection region may include an upper-end surface and a lower-end surface that are parallel to each other in a horizontal direction.

A rear end of the total reflection region may have a concave shape opening vertically upward and downward.

The first reflection surface may be disposed at a rear end in an upper region of the incident lens.

The first reflection surface may extend in a width direction in which the one or more third light source parts are disposed.

The first reflection surface may be a flat surface inclined downward and forward.

The second reflection surface may be formed in a lower end region of the incident lens and face the first reflection surface in the vertical direction.

A cross-section of the second reflection surface, taken in a direction intersecting a lateral direction of the lamp, may have a curved surface shape.

The first lens portion may include a first body portion formed integrally with a front side of the one or more first light source parts and configured to totally reflect the light beams introduced from the one or more first light source parts and guide the light beams forward, and a front surface of the first body portion may be a curved surface having a horizontal cross-sectional shape that is concavely curved toward the emergent lens.

The second lens portion may include a second body portion formed integrally with a front side of the one or more second light source parts and configured to totally reflect the light beams introduced from the one or more second light source parts and guide the light beams forward, and a front surface of the second body portion may have a horizontal cross-sectional shape that is straight in a horizontal direction.

The first emergent lens part may include: a first incident surface formed as a curved surface having a horizontal cross-sectional shape that is convexly curved toward the first lens portion; and a first emergent surface formed as a curved surface having a horizontal cross-sectional shape that is convexly curved forward.

The second emergent lens part may include: a second incident surface having a horizontal cross-sectional shape extending from one side of the first incident surface and the second incident surface being concavely curved toward the second lens portion; and a second emergent surface connected to one side of the first emergent surface and convexly curved forward.

According to the present disclosure, it is possible to eliminate non-uniformity of images, which occurs when the low beam is turned on together with the high beam, and improve heterogeneity of light-emitting images of the high and low beams.

### BRIEF DESCRIPTION OF THE DRAWINGS

FIG. 1 is a perspective view illustrating a lamp for a vehicle according to the present disclosure.

FIG. 2 is a top plan view illustrating the lamp for a vehicle according to the present disclosure.

FIG. 3 is a rear view illustrating the lamp for a vehicle according to the present disclosure.

FIG. 4 is a right side view illustrating the lamp for a vehicle according to the present disclosure.

FIG. 5 is a view illustrating a light-emitting image of the lamp for a vehicle according to the present disclosure.

FIG. 6 is a view illustrating an image of a total reflection region of the lamp for a vehicle according to the present disclosure.

### DETAILED DESCRIPTION

Hereinafter, a lamp for a vehicle according to the present disclosure will be described with reference to the drawings.

### Lamp for Vehicle

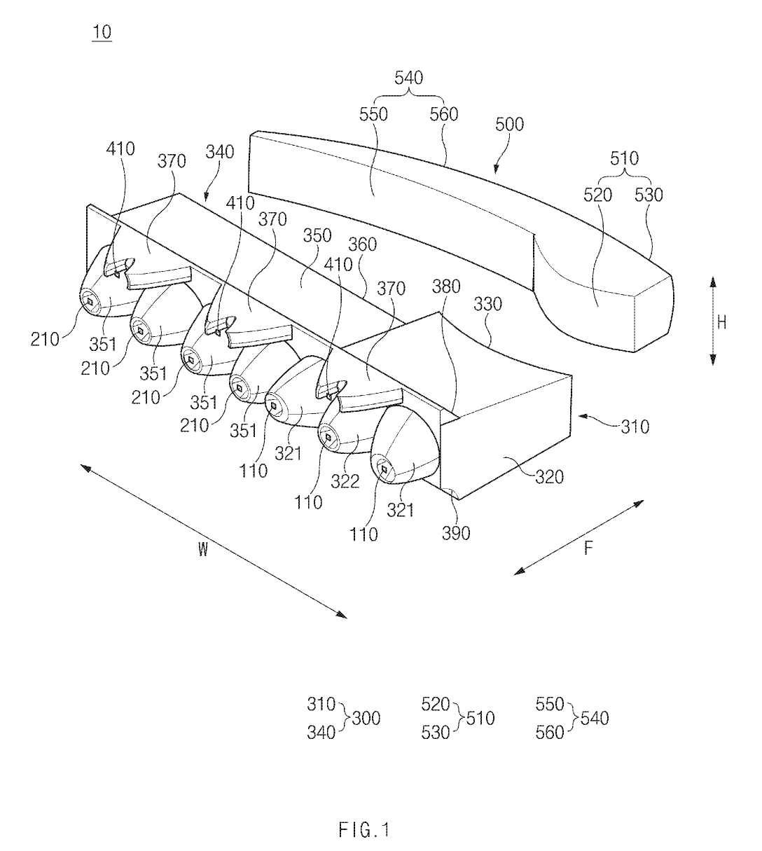

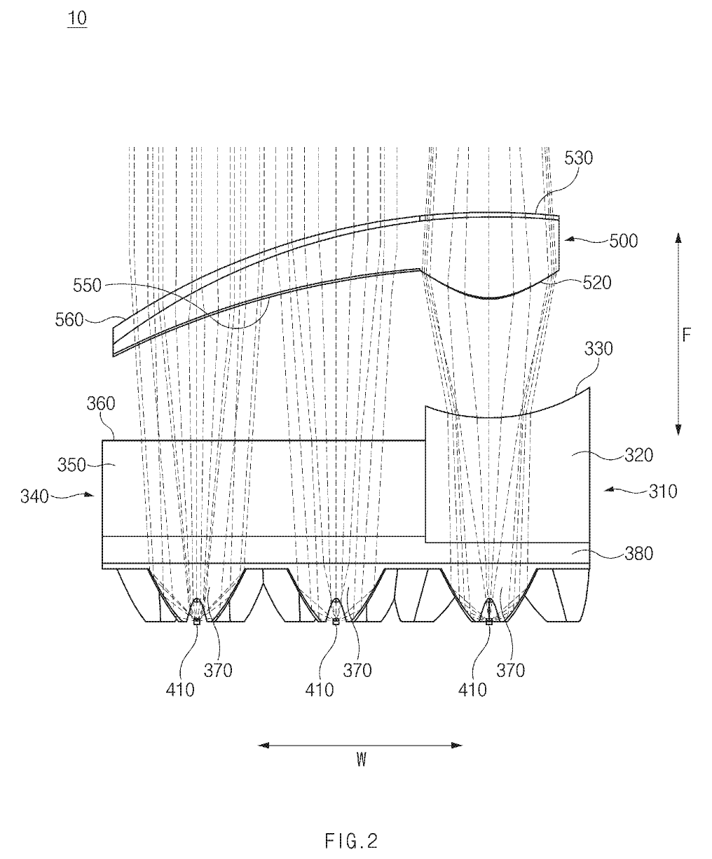

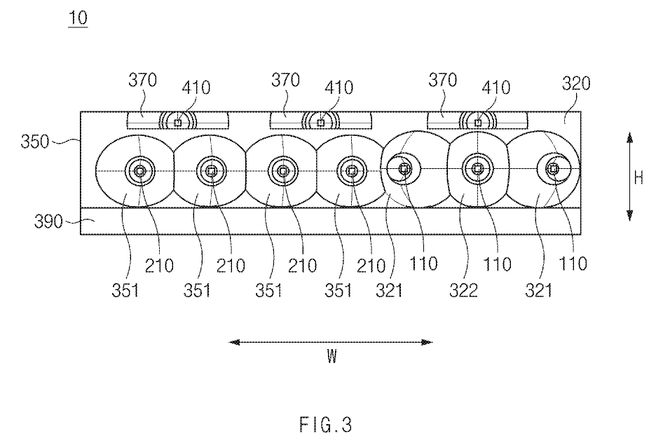

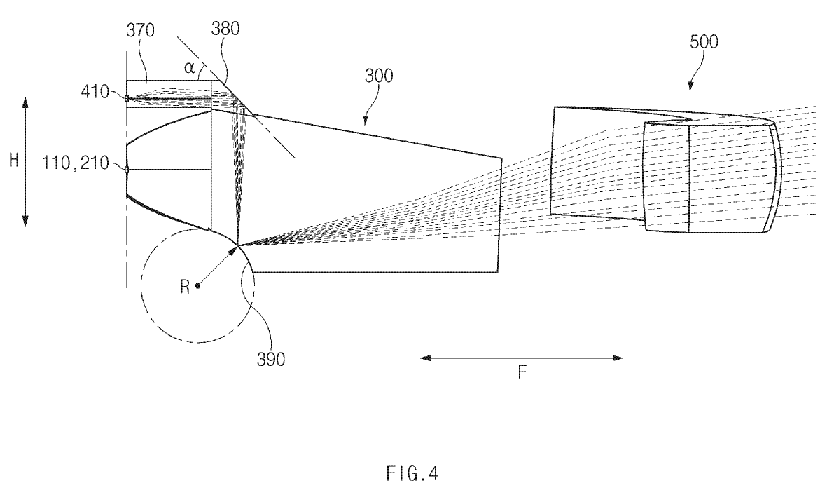

FIG. 1 is a perspective view illustrating a lamp for a vehicle according to the present disclosure, and FIG. 2 is a top plan view illustrating the lamp for a vehicle according to the present disclosure. FIG. 3 is a rear view illustrating the lamp for a vehicle according to the present disclosure. FIG. 4 is a right side view illustrating the lamp for a vehicle according to the present disclosure.

As illustrated in FIGS. 1-4, a lamp 10 for a vehicle according to the present disclosure includes some or all of a first light source unit 100, a second light source unit 200, a third light source unit 400, an incident lens 300, and an emergent lens 500. One or both of the first light source unit 100 and the second light source unit 200 according to the present disclosure may be optical systems for forming low-beam light distribution patterns.

The first light source unit 100 according to the present disclosure includes first light source parts 110. The first light source unit 100 includes one or more first light source parts 110. For example, a plurality of light sources (not illustrated) may be disposed in the first light source parts 110. For example, the light source may be a light-emitting element configured to emit a light beam. For example, the light source may be a light-emitting diode (LED).

The first light source unit 100 may be disposed at one side based on a leftward/rightward direction W of the lamp 10 for a vehicle.

Although not illustrated in FIGS. 1-3, a PCB (not illustrated) may be disposed rearward of the lamp 10 for a vehicle. The plurality of light sources according to the present disclosure may be mounted on the PCB. Therefore, in case that the PCB is disposed rearward of the lamp 10 for a vehicle, the plurality of light sources mounted on the PCB may be disposed adjacent to the first light source parts 110.

FIGS. 1-3 illustrate that the number of first light source parts 110 is three. However, the present disclosure is not limited thereto. One or more first light source parts 110 may be provided.

Meanwhile, according to the present disclosure, first-first total reflection lenses 321 and a first-second total reflection lens 322 may guide the light beams, which are emitted from the first light source parts 110, forward. Specifically, the first-first total reflection lens 321 and the first-second total reflection lens 322 may be total internal reflection (TIR) lenses that guide and condense the light beams introduced by total internal reflection.

The first-first total reflection lenses 321 may be provided at two opposite sides in the leftward/rightward direction W based on the first-second total reflection lens 322. Specifically, two first-first total reflection lenses 321 may be provided to be symmetric with respect to the first-second total reflection lens 322.

The first-first total reflection lens 321 and the first-second total reflection lens 322 may each be formed in a radial shape widened forward based on a position of the first light source part 110. In particular, the first-first total reflection lens 321 may be formed in a shape inclined toward the first-second total reflection lens 322 with respect to a forward/rearward direction F. Specifically, an optical axis of the first-first total reflection lens 321 may be inclined toward the first-second total reflection lens 322.

Based on the shape of the first-first total reflection lens 321, the optical axes of the first-first total reflection lenses 321 provided at the two opposite sides of the first-second total reflection lens 322 may intersect an optical axis of the first-second total reflection lens 322.

The second light source unit 200 according to the present disclosure includes second light source parts 210.

The second light source unit 200 may be disposed at one side of the first light source unit 100.

The second light source unit 200 includes one or more second light source parts 210. For example, a plurality of light sources (not illustrated) may be disposed in the second light source parts 210. Like the first light source parts 110, the plurality of light sources mounted on the PCB may be positioned rearward of the second light source parts 210.

Second total reflection lenses 351 may guide the light beams, which are emitted from the second light source parts 210, forward.

One or more second total reflection lenses 351 may be provided. The second total reflection lenses 351 may be aligned in the leftward/rightward direction W of the lamp 10 for a vehicle.

The incident lens 300 according to the present disclosure is integrated with the first-first total reflection lens 321, the first-second total reflection lens 322, and the second total reflection lens 351.

The light beams emitted from the first light source unit 100 and the second light source unit 200 enter the incident lens 300. Specifically, the light beams, which are emitted from the first light source parts 110 and reflected by the first-first total reflection lenses 321 and the first-second total reflection lens 322, may enter the incident lens 300, and the light beams, which are emitted from the second light source parts 210 and reflected by the second total reflection lenses 351, may enter the incident lens 300.

An upper surface of the incident lens 300 according to the present disclosure is formed to be inclined downward toward the emergent lens 500.

The incident lens 300 according to the present disclosure includes a first lens 310 and a second lens 340.

The first lens 310 according to the present disclosure guides the light beams, which are emitted from the first light source unit 100, toward the emergent lens 500. The first lens 310 may guide the light beams, which are reflected by the first-first total reflection lenses 321 and the first-second total reflection lens 322, toward the emergent lens 500.

The first lens 310 includes a first body portion 320. The first body portion 320 may be formed integrally with the first-first total reflection lenses 321 and the first-second total reflection lens 322. In other words, the first-first total reflection lenses 321 and the first-second total reflection lens 322 may each be provided on a rear side surface of the first body portion 320 and formed integrally with the first body portion 320.

The first body portion 320 according to the present disclosure includes a first light exit surface 330 as a front surface thereof. The first light exit surface 330 may be formed as a curved surface. Specifically, the first light exit surface 330 may have a horizontal cross-sectional shape formed as a shape concavely curved toward the emergent lens 500.

The second lens 340 according to the present disclosure guides the light beams, which are emitted from the second light source unit 200, toward the emergent lens 500. The second lens 340 may guide the light beams, which are reflected by the second total reflection lenses 351, toward the emergent lens 500.

The second lens 340 includes a second body portion 350. The second body portion 350 may be formed integrally with the second total reflection lenses 351 and disposed forward of the second total reflection lenses 351.

The second body portion 350 according to the present disclosure includes a second light exit surface 360 as a front surface thereof. The second light exit surface 360 may have a horizontal cross-sectional shape formed straight based on the horizontal direction.

An upper surface of the second lens 340 according to the present disclosure is formed to be stepped downward with respect to an upper surface of the first lens 310.

The third light source unit 400 according to the present disclosure includes third light source parts 410.

A plurality of light sources (not illustrated) may be disposed in the third light source parts 410. For example, the plurality of light sources disposed in the third light source parts 410 may be mounted on the PCB on which the plurality of light sources disposed in the first and second light source parts 110 and 210 are mounted. Therefore, the light sources of the first to third light source parts 110, 210, and 410 may be disposed on the same plane.

The incident lens 300 according to the present disclosure includes total reflection regions 370. The total reflection regions 370 refer to regions that guide the light beams, which are emitted from the third light source parts 410, forward. Specifically, the total reflection region 370 may be a total internal reflection (TIR) lens that guides and condenses the light beams introduced by total internal reflection.

The total reflection region 370 according to the present disclosure may be formed integrally with the incident lens 300 and protrude rearward from an upper end region of the incident lens 300. The total reflection regions 370 are provided as a plurality of total reflection regions 370 formed in the upper end region of the incident lens 300 in the leftward/rightward direction W of the incident lens 300.

The total reflection region 370 includes an upper-end surface and a lower-end surface. The upper-end surface and the lower-end surface of the total reflection region 370 are formed on upper and lower portions of the total reflection region 370 and formed in parallel with each other based on the horizontal direction of the lamp 10 for a vehicle.

A rear end of the total reflection region 370 has a shape concavely opened upward and downward. When the PCB is coupled to a rear side of the lamp 10 for a vehicle, the plurality of light sources of the third light source parts 410 may be positioned at the rear ends of the total reflection regions 370.

The incident lens 300 according to the present disclosure includes a first reflection surface 380 and a second reflection surface 390.

The first reflection surface 380 may be formed in an upper region of the incident lens 300 in a height direction H. Specifically, the first reflection surface 380 may be formed at a rear end of the incident lens 300 in the upper region of the incident lens 300.

The first reflection surface 380 may be formed as a flat surface. More specifically, the first reflection surface 380 may have an inclined surface shape directed downward and forward. Therefore, the first reflection surface 380 may reflect, downward, the light beams that are emitted from the third light source parts 410 and guided forward by being reflected by the total reflection regions 370.

The second reflection surface 390 is formed in a lower end region of the incident lens 300 in the height direction H.

The second reflection surface 390 may be formed to face the first reflection surface 380 in an upward/downward direction.

The lamp 10 for a vehicle according to the present disclosure has a structure in which the light beams emitted from the third light source parts 410 are reflected by the first reflection surface 380 and the second reflection surface 390. In other words, when the lamp 10 for a vehicle is viewed in a lateral direction, the light beams emitted from the first light source parts 110 and the second light source parts 210 propagate toward the emergent lens 500 via the incident lens 300, thereby representing straight-line-based optical paths. In contrast, the light beams emitted from the third light source parts 410 have curved-line-based optical paths in the incident lens 300 by means of the first reflection surface 380 and the second reflection surface 390.

A shape of a cross-section of the second reflection surface 390, which is made by cutting the second reflection surface 390 in a direction intersecting the leftward/rightward direction W, may be formed as a curved surface shape. The light beams reflected by the second reflection surface 390 represent a light distribution in which the light beams are distributed in the height direction H when the light beams propagate toward the emergent lens 500. For example, the light distribution refers to a spatial distribution of light beams emitted from a light source.

The light beams reflected by the second reflection surface 390 and distributed in the height direction H form a relatively large light distribution without being condensed at a single focal point. For example, the light beams, which are emitted from the third light source parts 410 and form the large light distribution, reduce the occurrence of bright spots in an image formed at a front side of the vehicle in comparison with light beams distributed at a single focal point.

The lamp 10 for a vehicle according to the present disclosure may use the third light source unit 400 in order to eliminate non-uniformity and interruption of images in the light distribution patterns formed by the first light source unit 100 and the second light source unit 200. This is because the light distribution pattern formed by the third light source unit 400 may compensate for interrupted regions of the light distribution patterns formed by the first light source unit 100 and the second light source unit 200 based on the light distribution pattern having the light distribution in the height direction.

The light beams exiting the incident lens 300 enter the emergent lens 500 according to the present disclosure.

The emergent lens 500 may have a shape asymmetric in the leftward/rightward direction.

Emergent surfaces 530 and 560 of the emergent lens 500 may have curved shapes curved rearward in a direction from one end to the other opposite end based on the leftward/rightward direction W of the lamp 10 for a vehicle.

The emergent lens 500 according to the present disclosure includes a first emergent lens part 510 and a second emergent lens part 540.

The first emergent lens part 510 includes a first incident surface 520 and a first emergent surface 530.

The first incident surface 520 of the first emergent lens part 510 is formed as a curved surface. Specifically, the first incident surface 520 has a horizontal cross-sectional shape formed as a shape convexly curved in a direction toward the first lens 310 (rearward).

The first emergent surface 530 has a horizontal cross-sectional shape formed as a shape convexly curved forward.

The second emergent lens part 540 includes a second incident surface 550 and a second emergent surface 560.

The second incident surface 550 has a horizontal cross-sectional shape extending from one side of the first incident surface 520. The second incident surface 550 is formed in a shape concavely curved in a direction toward the second lens 340 (rearward).

The second emergent surface 560 is formed in a shape convexly curved forward. The second emergent surface 560 has a horizontal cross-sectional shape continuously connected to one side of the first emergent surface 530.

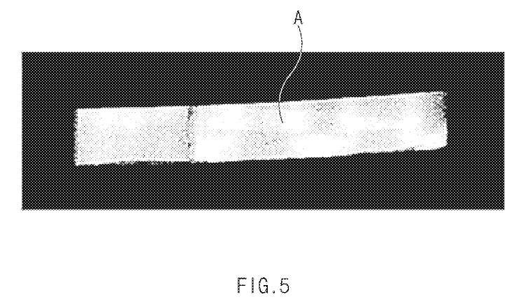

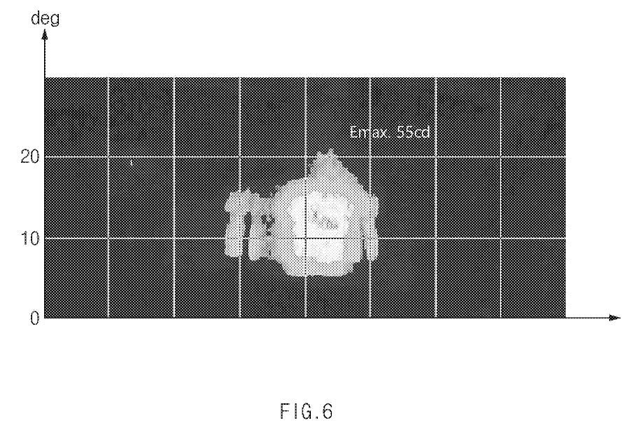

FIG. 5 is a view illustrating a light-emitting image of the lamp for a vehicle according to the present disclosure. FIG. 6 is a view illustrating an image of the total reflection region of the lamp for a vehicle according to the present disclosure.

With reference to the above-mentioned description, the total reflection region 370 provided in the lamp 10 for a vehicle according to the present disclosure has a large light distribution based on the curved-line-based optical path, such that a continuous light distribution pattern A may be implemented, as illustrated in FIG. 5.

In addition, a light-emitting image, which is formed as the light beams emitted from the third light source unit 400 and propagating through the total reflection regions 370 according to the present disclosure are reflected by the first reflection surface 380 and the second reflection surface 390, may represent a light distribution of less than 100 cd between 0 and 20 degrees, for example.

The first-first total reflection lenses 321, the first-second total reflection lens 322, and the second total reflection lenses 351 according to the present disclosure form the low-beam light distribution pattern by guiding the light beams, which are emitted from the first light source parts 110 and the second light source parts 210, forward. In contrast, the total reflection regions 370 according to the present disclosure guide the light beams, which are emitted from the third light source parts 410, forward, thereby forming an auxiliary light distribution pattern formed separately from the low-beam light distribution pattern to assist the low-beam light distribution pattern.

Therefore, the lamp 10 for a vehicle according to the present disclosure may form the auxiliary light distribution pattern by using the total reflection regions 370, the first reflection surface 380, and the second reflection surface 390, thereby improving the heterogeneity of the light-emitting images formed at the t side of the vehicle.

### Vehicle

A vehicle according to the present disclosure may include the lamp 10 for a vehicle.

For example, the lamp 10 for a vehicle may include the light source unit 100 including one or more first light source parts 110 and disposed at one side based on the leftward/rightward direction, the second light source unit 200 including one or more second light source parts 210 and disposed at one side of the first light source unit 100, and the third light source unit 400 including one or more third light source parts 410 and disposed above the first light source unit 100 and the second light source unit 200. In addition, the lamp 10 for a vehicle may include the incident lens 300 integrated with the first lens 310 and the second lens 340, the first lens 310 being configured to condense the light beams emitted from the first light source parts 110 and allow the light beams to propagate forward, and the second lens 340 being integrated with the first lens 310, formed at the other side of the first lens 310, and configured to condense the light beams emitted from the second light source parts 210 and allow the light beams to propagate forward, and the emergent lens 500 disposed forward of the first lens 310 and the second lens 340 and including the first emergent lens part 510 and the second emergent lens part 540 integrated with each other. In addition, the incident lens 300 may be formed with the first reflection surface 380 and the second reflection surface 390 spaced apart from each other in the upward/downward direction, and the light beams emitted from the third light source unit 400 may be sequentially reflected by the first reflection surface 380 and the second reflection surface 390 and then enter the emergent lens 500.

Meanwhile, the above-mentioned description of the lamp for a vehicle according to the present disclosure may also be equally applied to the lamp provided in the vehicle according to the present disclosure.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A lamp for a vehicle, comprising:
a first light source unit comprising one or more first light source parts and disposed at one lateral side;
a second light source unit comprising one or more second light source parts and disposed laterally adjacent to the first light source unit;
a third light source unit comprising one or more third light source parts and disposed above the first light source unit and the second light source unit;
an incident lens formed as an integral body comprising a first lens portion and a second lens portion, wherein the first lens portion is configured to condense light beams emitted from the one or more first light source parts and guide the light beams forward, and wherein the second lens portion is disposed adjacent to the first lens portion and is configured to condense light beams emitted from the one or more second light source parts and guide the light beams forward; and
an emergent lens disposed forward of the incident lens and comprising a first emergent lens part and a second emergent lens part integrated with each other,
wherein the incident lens comprises a first reflection surface and a second reflection surface spaced apart from each other in a vertical direction, and
wherein the incident lens is configured such that light beams emitted from the third light source unit are sequentially reflected by the first reflection surface and the second reflection surface before entering the emergent lens.

2. The lamp of claim 1, wherein an upper surface of the incident lens is formed to be inclined downward toward the emergent lens.

3. The lamp of claim 2, wherein an upper surface of the second lens portion is stepped downward related to an upper surface of the first lens portion.

4. The lamp of claim 1, wherein the incident lens further comprises a total reflection region configured to condense the light beams emitted from the one or more third light source parts and guide the light beams forward.

5. The lamp of claim 4, wherein the total reflection region protrudes rearward from an upper end region of the incident lens.

6. The lamp of claim 4, wherein the total reflection region comprises an upper-end surface and a lower-end surface that are parallel to each other in a horizontal direction.

7. The lamp of claim 6, wherein a rear end of the total reflection region has a concave shape vertically upward and downward.

8. The lamp of claim 1, wherein the first reflection surface is disposed at a rear end of an upper region of the incident lens.

9. The lamp of claim 8, wherein the first reflection surface extends in a width direction in which the one or more third light source parts are disposed.

10. The lamp of claim 8, wherein the first reflection surface is a flat surface inclined downward and forward.

11. The lamp of claim 1, wherein the second reflection surface is formed in a lower end region of the incident lens and faces the first reflection surface in the vertical direction.

12. The lamp of claim 1, wherein a cross-section of the second reflection surface, taken in a direction intersecting a lateral direction of the lamp, is formed as a curved surface shape.

13. The lamp of claim 1, wherein the first lens portion comprises a first body portion formed integrally with a front side of the one or more first light source parts, the first body portion configured to totally reflect the light beams introduced from the one or more first light source parts and guide the light beams forward, and
wherein a front surface of the first body portion is a curved surface having a horizontal cross-sectional shape that is concavely curved toward the emergent lens.

14. The lamp of claim 1, wherein the second lens portion comprises a second body portion formed integrally with a front side of the one or more second light source parts, the second body portion configured to totally reflect the light beams introduced from the one or more second light source parts and guide the light beams forward, and
wherein a front surface of the second body portion has a horizontal cross-sectional shape that is straight in a horizontal direction.

15. The lamp of claim 1, wherein the first emergent lens part comprises:
a first incident surface formed as a curved surface having a horizontal cross-sectional shape that is convexly curved toward the first lens portion; and
a first emergent surface formed as a curved surface having a horizontal cross-sectional shape that is convexly curved forward.

16. The lamp of claim 15, wherein the second emergent lens part comprises:
a second incident surface having a horizontal cross-sectional shape extending from one side of the first incident surface, the second incident surface being concavely curved toward the second lens portion; and
a second emergent surface connected to one side of the first emergent surface and convexly curved forward.
